(19) United States
(12) Patent Application Publication
(10) Pub. No.: US 2006/0237607 A1
(43) Pub. Date: Oct. 26, 2006

(54) Universal mounting bracket

(76) Inventor: John Rexroad, Killingworth, CT (US)

Correspondence Address: VENABLE, CAMPILLO, LOGAN & MEANEY, P.C., 1938 E. OSBORN RD, PHOENIX, AZ, 85016-7234, US

(21) Appl. No.: 11/089,621

(22) Filed: Mar. 24, 2005

(51) Int. Cl. G09F 7/18

(52) U.S. Cl. 248/228.1

(57) ABSTRACT

Described is an adjustable mounting bracket used to secure a net system to buildings. The adjustable mounting bracket easily and quickly attaches to a floor beam or other structure around the perimeter of a building. The adjustable mounting bracket includes a mounting bracket, a support mount, a support bracket, and a cantilever arm. The mounting bracket is adjustable and also reinforces the support mount and the support bracket. The support bracket attaches to two cantilever arms that are positioned perpendicularly around the corner of a building. The cantilever arms are attached to the support bracket with pivot pins that allow the cantilever arms to rotate. The debris net is suspended between the upper end of the cantilever arm and the building. Among other things, the adjustable mounting bracket allows for easy installation of a net system around a building undergoing construction or maintenance.

### BACKGROUND

The present invention relates generally to an apparatus used for securing a device to a structure, more particularly, to an apparatus that secures a net system around the perimeter of a building or structure to ensure a safe work area for construction crews, members of the public, and property that are near a building undergoing construction or renovations. Specifically, the present invention utilizes an adjustable mounting bracket that attaches to a variety of sizes of support structures and rigidly secures a net system to a building or structure under construction.

A crew maintaining or constructing a building or structure must deal with many hazards in the work environment. Members of the crew on the ground and in the air must be constantly aware of their surroundings to prevent injuries from falls or falling objects. Additionally, the public on the premises of a construction or maintenance project must be aware of potentially hazardous situations, such as dropped objects falling from above that could cause bodily injury or property damage.

One way to ensure protection of the crew, public, and property is to install a net system that surrounds the perimeter of the building or structure near the area where objects may fall. However, the installation process of the net system can be difficult because most buildings or structures have support structures that vary in size and width from building to building. Therefore, there is not one standard size bracket that will attach a net system to the support structures of every building or structure. This can become problematic and time consuming for a crew trying to install a net system because the mounting bracket will have to be measured and changed each time the net system is moved from building to building. Because the process of installing the bracket is so time consuming, a crew may not take the time to properly secure the net system, ultimately causing serious accidents.

The present invention provides crew members with an easy and secure way to fasten a net system around the perimeter of all sizes of buildings or structures. The present invention is a mounting bracket that includes a separate top piece and bottom piece that are adjustably connected to fit varying sizes of support structures. The top piece and bottom piece each include overlapping members with holes that line up. When the desired distance between the top and bottom pieces is reached, a bolt or other securing device is inserted into the holes to secure the top piece and bottom piece of the mounting bracket together. Additionally, an extension plate can be attached to the overlapping members when the support structure is larger than the top and bottom piece can fit around.

Further, the top pieces of the mounting brackets include a slot where a cantilever beam is inserted. The cantilever beam is secured in the slot with a pivot pin so that the cantilever beam can rotate. The adjustability of the mounting bracket is critical because crews must be able to secure the mounting bracket to various size buildings.

Currently, there are devices that attach net systems to buildings or structures to protect people working on construction crews, members of the public accessing areas below the building or structure, and property on the ground that could be damaged by falling objects. However, each of these devices suffers from several disadvantages. First, the devices are difficult to install on varying sizes of building support structures. Because the support structures vary in size from building to building, each mounting bracket must be changed on the net system every time it is installed on a different building. This can become time consuming and may result in an accident caused by human mistakes. Second, the prior art devices are complicated and require a time consuming and inconvenient process to install and secure.

Presently, there is no net system that is easy to install on varying sizes of support structures. For the foregoing reasons, there is a need for a device that would allow construction crews to easily install a mounting bracket that supports a net system around a building or structure with varying sizes of support structures.

### SUMMARY

The present invention is directed to a device that satisfies the needs of providing a mounting bracket that is easy to install on varying sizes of building support structures, providing a mounting bracket that is adjustable, providing a mounting bracket that allows a cantilever beam to be folded up against the building for cleaning or in inclement weather conditions, and providing amounting bracket that quickly and easily secures to support structures.

A mounting system having features of the present invention comprises a mounting bracket with a top piece and bottom piece that are adjustably connected to each other. The top and bottom pieces of the mounting bracket include overlapping members with holes that line up. A fastener such as a bolt is inserted into the holes to secure the top and bottom pieces of the mounting bracket when the mounting bracket is the preferred width. The top piece of the mounting bracket can include a slot where a cantilever beam is inserted and rotates. This configuration allows a net system to be attached to the mounting bracket.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C §112, paragraph 6 to define the invention. To the contrary, if the provisions of 35 U.S.C §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C 5112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a perspective view of the universal mounting bracket.

FIG. 2 shows a side view of the universal mounting bracket attached to a parapet wall.

FIG. 3 shows a side view of the universal mounting bracket attached to an I-beam.

FIG. 4 shows a side view of the universal mounting bracket attached to a decorative wall.

FIG. 5 shows a side view of the universal mounting bracket attached to a column and looking down onto the column.

FIG. 6 shows a back view of the universal mounting bracket attached to a column and looking at the side of the column.

FIG. 7 shows a side view of the universal mounting bracket attached to a support structure with a cantilever beam folded over the support structure.

FIG. 8 shows a side view of the universal mounting bracket attached to a support structure with a cantilever beam in a vertical position.

FIG. 9 shows a side view of the universal mounting bracket attached to a support structure with a cantilever beam at an angle where a debris net would be hung above the universal mounting bracket.

FIG. 10 shows a side view of the universal mounting bracket attached to a support structure with a cantilever beam in a horizontal position where a debris net would be installed as a drop net.

### DESCRIPTION OF PREFERRED EMBODIMENTS

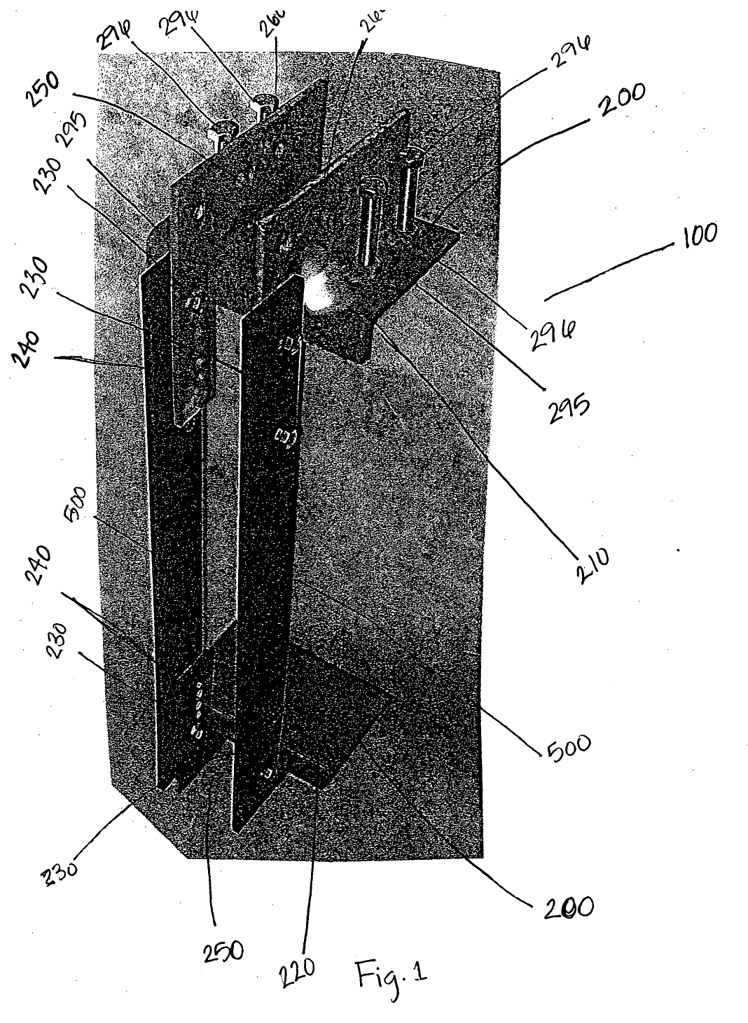

As shown in FIG. 1, the preferred embodiment of the universal mounting bracket 100 generally includes a pair of mounting brackets 200 that include slots 250 and overlapping members 230. These components work together with a cantilever beam 300 to secure a safety net system to buildings or structures with varying sizes of support structures, as shown in FIGS. 5-10. The mounting bracket 200 adjusts to fit varying sizes of support structures. The mounting bracket 200 is then secured by placing fasteners into the holes 240 on the overlapping members 230.

The mounting bracket 200 includes a top piece 210 and a bottom piece 220 that are detachably connected as depicted in FIG. 1. The overlapping members 230 of the top piece 210 and bottom piece 220 of the mounting bracket 200 comprise holes 240 evenly spaced apart. The overlapping member 230 of the top piece 210 fits on the inside of the overlapping member 230 of the bottom piece 220 such that the holes 240 are aligned and are secured with fasteners 280, such as bolts or pins. This configuration allows the top piece 210 and the bottom piece 220 to adjust to fit support structures with varying dimensions. Depending on the size of the support structure 400, the bottom piece 220 of the mounting bracket 200 can be moved closer to or further away from the top piece 210. This configuration provides the user an easy way to install a net system on a building without having to replace the bracket each time.

Also shown in FIG. 1 is an alternate embodiment of the universal mounting bracket 100 wherein the universal mounting bracket 100 includes extension plates 500. The extension plates 500 attach to the exteriors of the overlapping members 230 of the top piece 210 and the bottom piece 220 of the mounting bracket 200, and are used when the support structure 400 is wider than the overlapping members 230 can fit around. The extension plates 500 have holes 510 that line up with those on the overlapping members 230. Once the desired space between the top piece and bottom piece is achieved, fasteners 280 such as bolts or pins are inserted to secure the top piece 210 and bottom piece 220 together. The extension plates 500 provide added flexibility in the type of building or structure where the mounting system 100 can be used.

In addition to having holes 240 along the overlapping members 230, the mounting bracket 200 also has holes 260 along the edge 270 of the slot 250 of the top piece 210 of the mounting bracket 200 as shown in FIGS. 2-4. These holes 260 allow a cantilever beam 300 to be secured to the mounting bracket 200 with at least one pivot pin 310 as shown in FIGS. 9-12. The cantilever beam 300 is inserted into the slot 250 on the top piece 210 of the mounting bracket 200. The cantilever beam 300 is secured to the top piece 210 of the mounting bracket 200 with a pivot pin 310 so that the cantilever beam 300 can rotate. A net can be attached to the cantilever beam 300 to provide protection from falling objects. By providng a wa for the cantilever beam 300 to rotate, the net can be easily repaired and protected from inclement weather conditions.

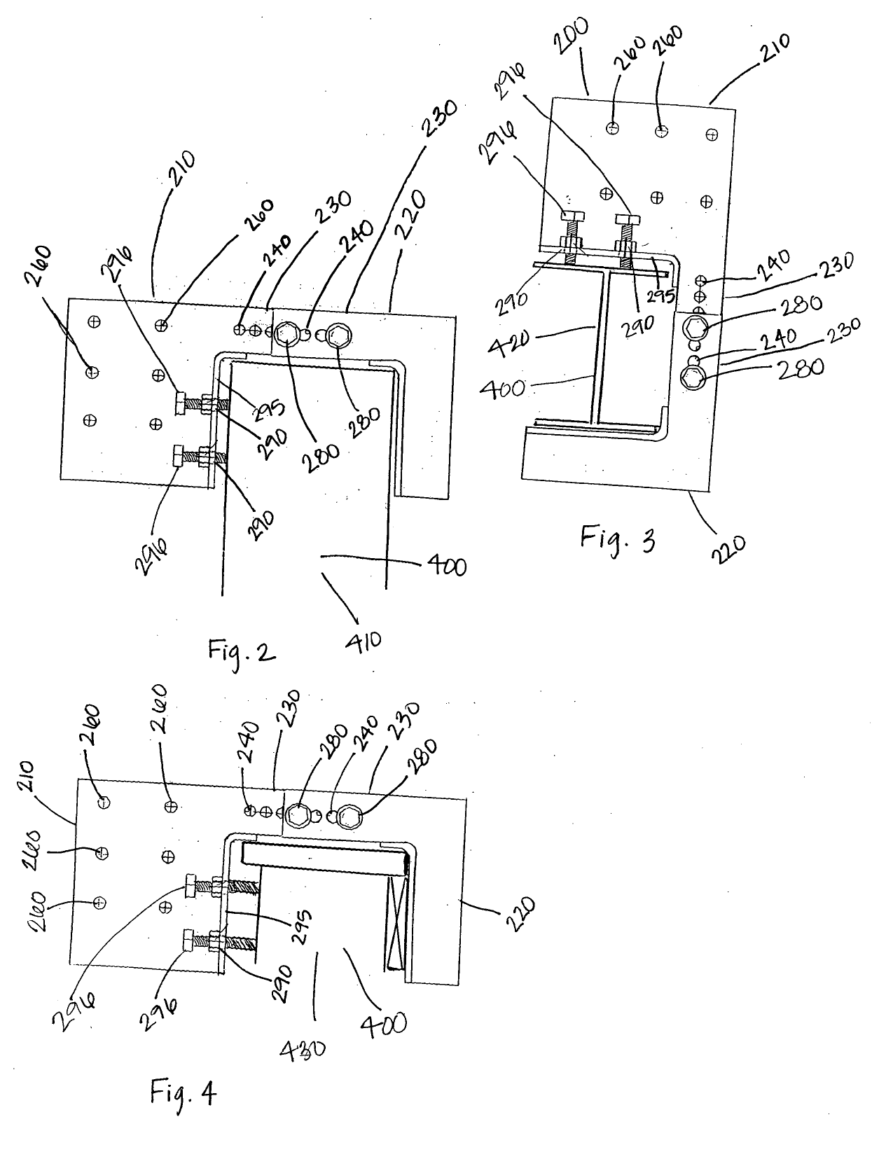

As shown in FIGS. 2-10, the top piece 210 of the mounting bracket 230 has holes 290 on both edges 295 outside the slot 250. Fasteners 296, such as bolts or pins, are inserted into these holes 290 to secure the mounting bracket 200 to the support structure 400. Various types and sizes of support structures 400 are shown in FIGS. 2-4 including, a parapet wall 410 in FIG. 2, an I-beam 420 in FIG. 3, and a decorative wall 430 in FIG. 4. Each of these support structures 400 can have different dimensions while still using the same mounting bracket 200 because of is ability to adjust.

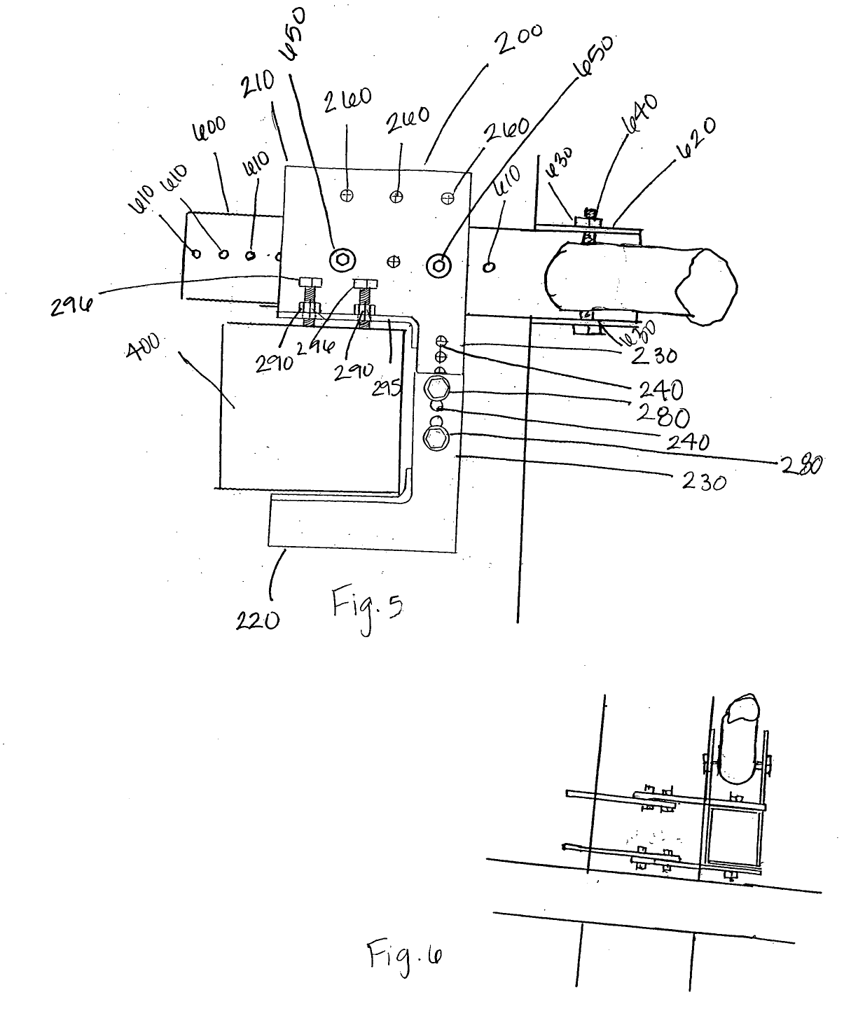

FIGS. 5 and 6 show two perspectives of an embodiment of the universal mounting bracket 100 with a cantilever extension arm 600 inserted into the slot 250 on the top piece 210 of the mounting bracket 200. The cantilever extension arm 600 is used when there is an obstruction, such as a column, that would make it infeasible to attach a cantilever beam 300 directly to the mounting bracket 200. In the preferred embodiment, the cantilever extension arm 600 includes holes 610 evenly spaced along the cantilever extension arm 600. The holes 610 of the cantilever extension arm 600 align with the holes 260 along the edge 270 of the slot 250 on the top piece 210 of the mounting bracket 200 and allow the cantilever extension arm 600 to adjust depending on the size of the obstruction. Once the desired placement is achieved, fasteners 650, such as bolts or pins, are inserted into the holes 610 to secure the cantilever extension arm 600 into the slot 250.

At the end of the cantilever extension arm 600 is a cantilever extension bracket 620. The cantilever extension bracket 620 includes two holes 630. A pivot pin 640 is inserted through the first hole 630, the cantilever beam 300, and the second hole 630 to secure the cantilever beam 300 in the cantilever extension bracket 620. The cantilever beam 300 can rotate around the axis of the pivot pin 640 allowing the cantilever beam 300 and attached safety net to adjust to various positions to repair and protect the net.

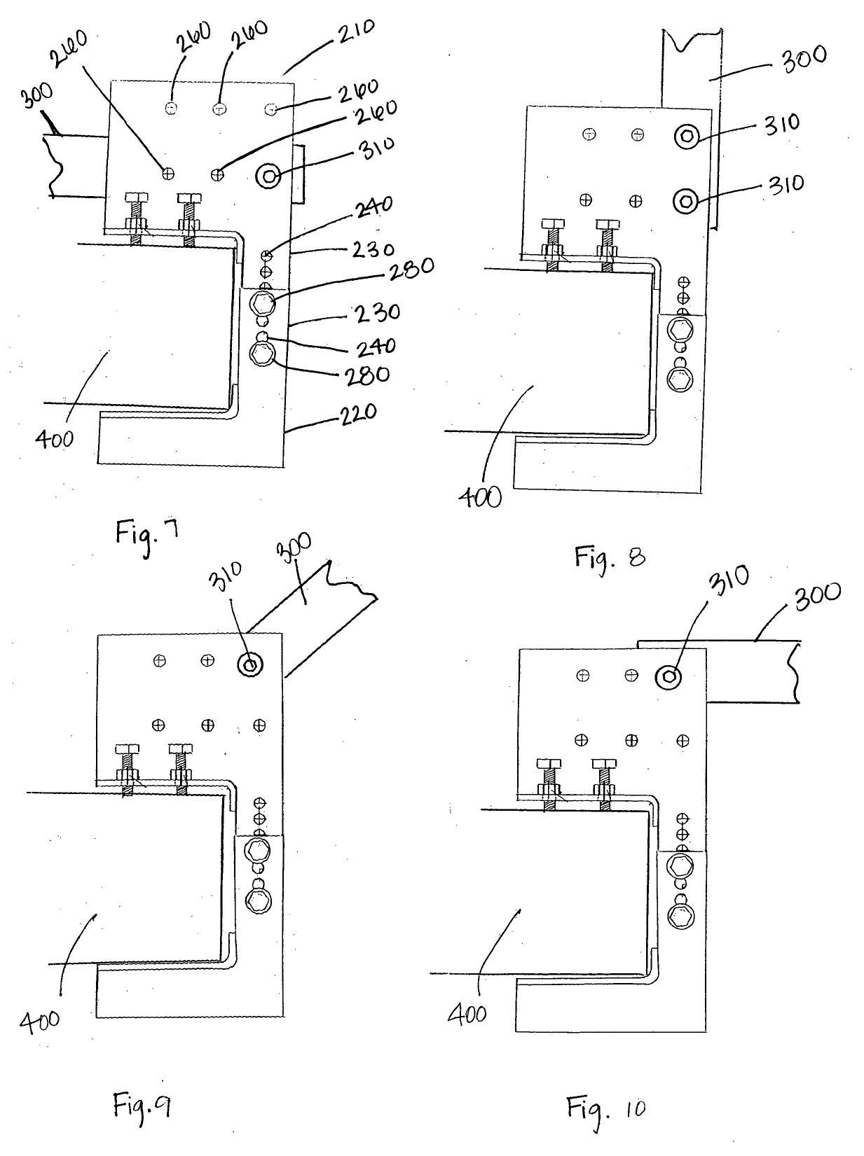

FIGS. 7-10 show the cantilever beam 300 attached to the mounting bracket 200 at various positions and positioned at various angles. In FIG. 7, the cantilever beam 300 is folded over the support structure 400. This configuration provides protection to the cantilever beam 300 and attached safety net in inclement weather, as well as providing the crew an easy and safe way to complete repairs or maintenance to the attached safety net. FIG. 8 depicts the cantilever beam 300 attached to the mounting bracket 200 with two pivot pins 310 and in a vertical configuration. The vertical configuration of the cantilever beam 300 shown in FIG. 8 provides support for a safety net that encloses part of a building structure. The cantilever beam 300 angle illustrated in FIG. 9 would require the safety net to be connected between the top of the cantilever beam 300 and a support structure 400 directly above the mounting bracket 200. Alternatively, the cantilever beam 300 angle depicted in FIG. 10 would require the safety net to be connected to both ends of the bottom side of the cantilever beam 300. In all instances, the cantilever beam 300 would be rotatable and provide the crew with an uncomplicated way to install, repair, and protect the safety net.

The preferred embodiment of the invention is described above, in the Drawings, and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A mounting system comprising:
A. a mounting bracket, said mounting bracket further comprising:
1. a top piece; and
2. a bottom piece;
B. said top piece of said mounting bracket is adjustably connected to said bottom piece of said mounting bracket; and
C. said top piece and said bottom piece of said mounting bracket further comprise overlapping members such that said overlapping members include holes.

2. The mounting system of claim 1 wherein:
A. said overlapping members of said top piece and said bottom piece of said mounting bracket are connected such that said holes are aligned along an axis perpendicular to said holes; and
B. at least one securing member is inserted into said holes to adjustably connect said top piece and said bottom piece of said mounting bracket.

3. The mounting system of claim 1 wherein said mounting system further comprises at least one cantilever beam, such that said cantilever beam is pivotally coupled to said mounting bracket.

4. The mounting system of claim 3 wherein:
A. said cantilever beam is pivotally coupled to said mounting bracket with at least one pivot pin; and
B. said pivot pin includes an axis, such that said cantilever beam rotates about said axis of said pivot pin.

5. The mounting system of claim 1 wherein said mounting bracket is coupled to a support structure wherein said top piece of said mounting bracket is attached to a first side of said support structure and said bottom piece of said mounting bracket is attached to a second side of said support structure.

6. The mounting system of claim 1 further comprising an extension plate such that said extension plate attaches to said top piece and said bottom piece of said mounting bracket.

7. A method for using a mounting system comprising the steps of:
A. connecting a top piece of a mounting bracket and a bottom piece of said mounting bracket to each other such that said top piece and said bottom piece are adjustable;
B. fitting an overlapping member of said top piece of said mounting bracket and an overlapping member of said bottom piece of said mounting bracket together wherein said overlapping member of said top piece and said overlapping member of said bottom piece include holes such that said holes are aligned along an axis perpendicular to said holes; and
C. inserting a securing member into said holes such that said top piece of said mounting bracket and said bottom piece of said mounting bracket are adjustably connected.

8. The method of claim 8 further comprising the step of pivotally coupling a cantilever beam to said mounting bracket.

9. The method of claim 9 further comprising the steps of:
A. coupling said cantilever beam pivotally to said mounting bracket with a pivot pin; and
B. rotating said cantilever beam about an axis of said pivot pin.

10. The method of claim 8 further comprising the step of coupling said mounting bracket to a support structure wherein said top piece of said mounting bracket is coupled to a first side of said support structure and said bottom piece of said mounting bracket is coupled to a second side of said support structure.
